(19) United States
(12) Patent Application Publication
(10) Pub. No.: US 2007/0040755 A1
(43) Pub. Date: Feb. 22, 2007

(54) BUILT-IN ANTENNA MODULE OF WIRELESS COMMUNICATION TERMINAL

(75) Inventors: GI LYONG NA, KYUNGKI-DO (KR); WOOK HEE LEE, KYUNGKI-DO (KR); JAE SUK SUNG, KYUNGKI-DO (KR)

Correspondence Address: LOWE HAUPTMAN BERNER, LLP, 1700 DIAGONAL ROAD, SUITE 300, ALEXANDRIA, VA, 22314, US

(73) Assignee: SAMSUNG ELECTRO-MECHANICS CO., LTD., KYUNGKI-DO (KR)

(21) Appl. No.: 11/459,111

(22) Filed: Jul. 21, 2006

(30) Foreign Application Priority Data
Aug. 18, 2005 (KR) 10-2005-0075841

(51) Int. Cl. H01Q 1/24

(52) U.S. Cl. 343/702

(57) ABSTRACT

Disclosed is a built-in antenna module of a wireless communication terminal. The built-in antenna module includes at least one base mounted on the upper surface of a substrate of a main body of the terminal; a radiator line formed in a designated pattern on the external surface of the base according to antenna characteristics; and at least one feeding terminal electrically connecting the radiator line and the substrate. The built-in antenna module simplifies a process for manufacturing the module, reduces production costs, and rapidly copes with the design change of an antenna.

### CLAIM OF PRIORITY

This application claims the benefit of Korean Patent Application No. 2005-75841 filed on Aug. 18, 2005, in the Korean Intellectual Property Office, the disclosure of which is incorporated herein by reference

### BACKGROUND OF THE INVENTION

1. Field of the Invention

The present invention relates to an antenna module installed in a wireless communication terminal, and more particularly to a built-in antenna module of a wireless communication terminal, in which a radiator is simply provided on the external surface of a base without any post process, thus reducing production costs.

2. Description of the Related Art

Generally, wireless communication terminals refer to portable communication apparatuses, which transmit/receive audio, character, and image data through wireless communication, such as a personal communication service (PCS) terminal, a personal digital assistant (PDA), a smart phone, an IMT-2000 terminal, and a wireless LAN terminal.

An antenna, such as a helical antenna or a dipole antenna, serving to improve the transmitting and receiving sensitivity, is installed in a wireless communication terminal. The antenna is an external antenna, which is protruded from the surface of the wireless communication terminal.

The external antenna has an advantage, such as a non-directional radiation property. On the other hand, the external antenna is protruded from the surface of the wireless communication terminal, thus being easily damaged by external force and causing inconvenience in carrying the wireless communication terminal and a difficulty in aesthetically designing the external appearance of the wireless communication terminal.

Accordingly, in order to solve the above problems of the external antenna, a built-in antenna having a flat structure, such as a micro strip patch antenna or an inverted F-type antenna, is employed in a wireless communication terminal.

FIG. 1 is an exploded perspective view of a terminal, a substrate of which is provided with a conventional built-in antenna module. As shown in FIG. 1, the conventional built-in antenna module 1 comprises a radiator 10 and a base 20.

The radiator 10 is made of a conductor, such as a conductive metal, so that the radiator 10 can receive/transmit a radio signal from/to a base station, and is formed by pressing and perforating a material having a sheet structure according to a predetermined pattern.

The base 20 is molded using a nonconductive resin, and is fixedly mounted on the substrate (M).

A plurality of assembly protrusions 22, which are inserted into assembly holes 12 of the radiator 10, are formed on the upper surface of the base 20 so that the radiator 10 can be fixedly mounted on the external surface of the base 20, and lower assembly extensions 24, which are inserted into lower assembly holes 23 of the substrate (M), are formed on the lower end of the base 20.

The substrate (M) is mounted on a lower casing 109, out of upper and lower casings, which form a main body of the terminal, and feeding terminals 15 of the radiator 10 mounted on the base 20 are electrically connected to the substrate (M).

In the conventional antenna module 1, in order to manufacture the radiator 10 having a designated pattern, a material having a sheet structure is pressed, and is perforated according to the predetermined pattern. Thereafter, a worker assembles the manufactured radiator 10 with the base 20.

Accordingly, a process for assembling the antenna module 1 is complicated, thus limiting the improvement of operating productivity and the reduction of production costs.

Further, in order to change the shape of the radiator 10 by means of the structural change of the base 20 and the design change of the radiator 10, a mold for pressing and perforating the material having the sheet structure must be replaced with a new one. Thereby, additional costs are required and a long time is taken to replace the equipment with another one, thus being incapable of rapidly coping with the design change of the antenna.

### SUMMARY OF THE INVENTION

Therefore, the present invention has been made in view of the above problems, and it is an object of the present invention to provide a built-in antenna module of a wireless communication terminal, which simplifies a process for manufacturing the module, reduces production costs, and rapidly copes with the design change of an antenna.

In accordance with the present invention, the above and other objects can be accomplished by the provision of a built-in antenna module of a wireless communication terminal comprising at least one base mounted on the upper surface of a substrate of a main body of the terminal; a radiator line formed in a designated pattern on the external surface of the base according to antenna characteristics; and at least one feeding terminal electrically connecting the radiator line and the substrate.

Preferably, the base includes at least one contact protrusion formed on the external surface thereof corresponding to the radiator line.

Preferably, the base is made of a nonconductive resin having a dielectric constant of more than 1.

Preferably, the radiator line is protruded from the external surface of the base by one method selected from the group consisting of a printing method, a coating method, and a double injection method.

Further, preferably, the radiator line fills a line groove formed in the external surface of the base by one method selected from the group consisting of a printing method, a coating method, and a double injection method.

More preferably, the line groove has a designated pattern according to the antenna characteristics.

Preferably, the radiator line is made of a conductive resin having a volume resistivity of 1,000Ωcm, which is obtained by adding a conductive material to a resin material.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view of a terminal, a substrate of which is provided with a conventional built-in antenna module;

FIGS. 2A and 2B respectively illustrate bases employed by a built-in antenna module of a wireless communication terminal in accordance with the present invention, and more specifically:

FIG. 2A is a perspective view of a base, which is not provided with any contact protrusion formed on the external surface thereof; and

FIG. 2B is a perspective view of another base, which is provided with contact protrusions formed on the external surface thereof;

FIG. 3 is a perspective view of the built-in antenna module in accordance with the present invention;

FIG. 4 is an exploded perspective view of a wireless communication terminal, which is provided with the built-in antenna module in accordance with the present invention; and

FIGS. 5A and 5B illustrate a modified base employed by the built-in antenna module in accordance with the present invention, and more specifically:

FIG. 5A is a perspective view of the modified base, which is provided with a line groove formed in the external surface thereof; and

FIG. 5B is a perspective view of the modified base, the line groove of which is filled with a radiator line.

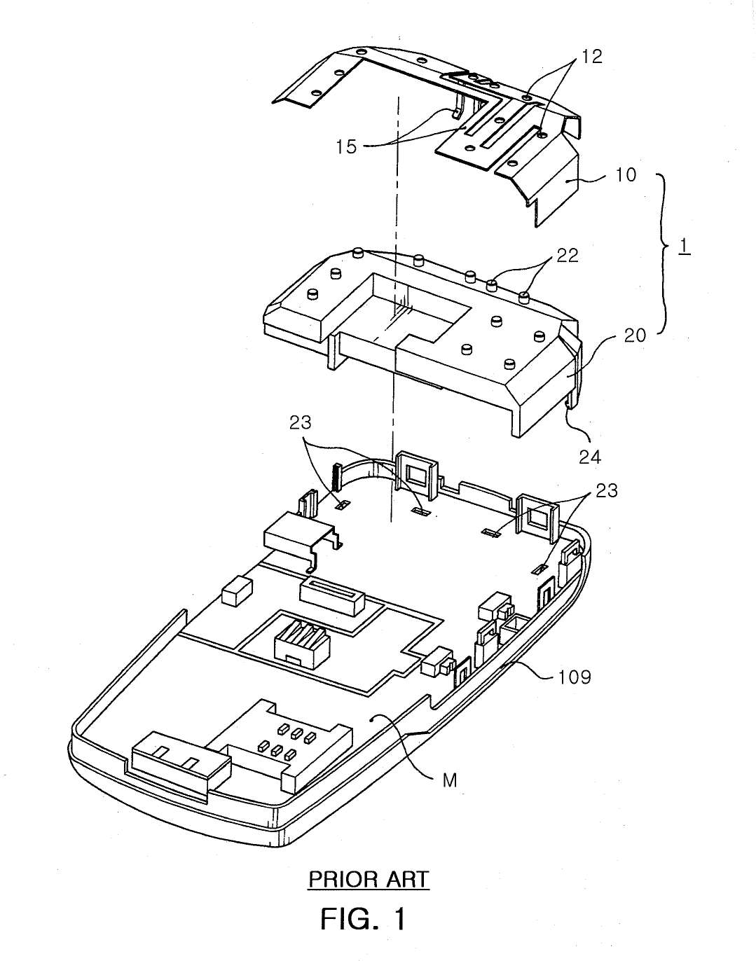

### DESCRIPTION OF THE PREFERRED EMBODIMENTS

Now, a preferred embodiment of the present invention will be described in detail with reference to the annexed drawings.

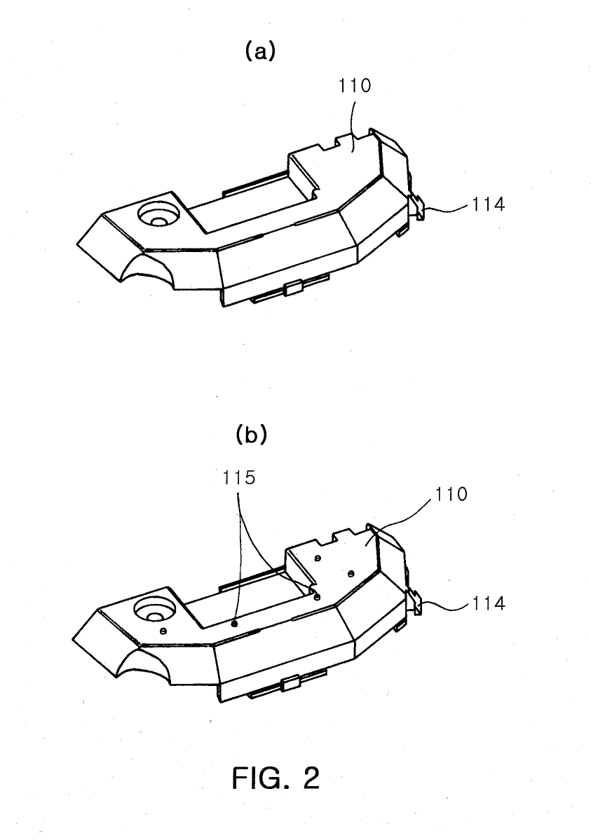

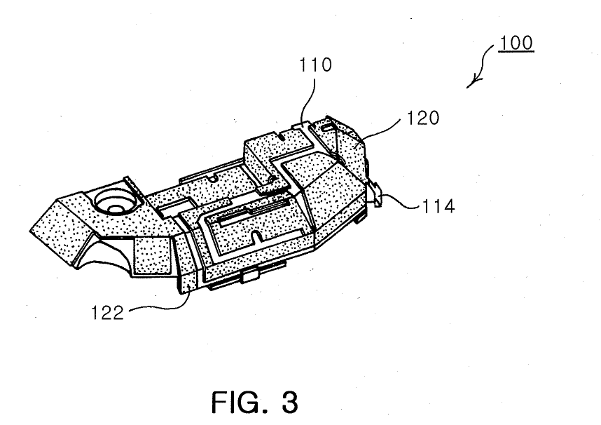

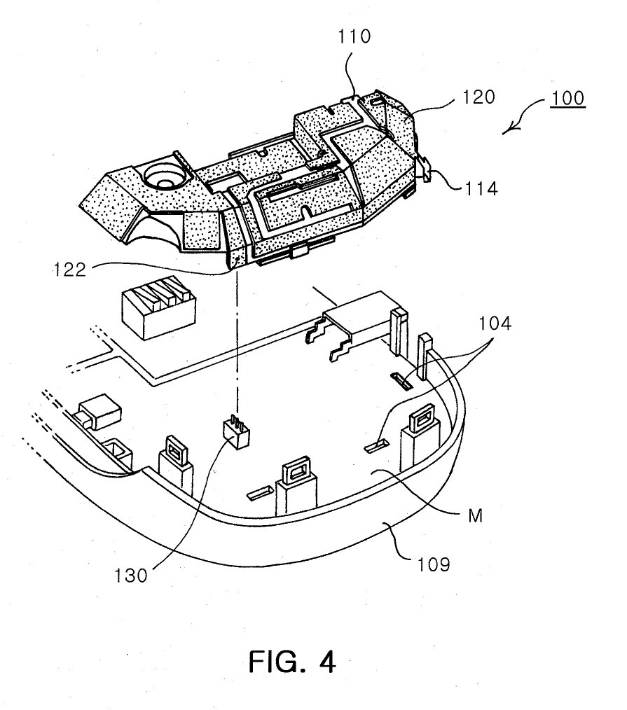

FIGS. 2A and 2B respectively illustrate bases employed by a built-in antenna module of a wireless communication terminal in accordance with the present invention, and more specifically, FIG. 3 is a perspective view of the built-in antenna module in accordance with the present invention, and FIG. 4 is an exploded perspective view of a wireless communication terminal, which is provided with the built-in antenna module in accordance with the present invention.

The antenna module 100 of the present invention has a structure in that a radiator manufactured without pressing and perforating is applied to a base without a post process, thus reducing production costs. As shown in FIGS. 2 to 4, the antenna module 10 comprises a base 110, a radiator line 120, and a feeding terminal 130.

At least one base 110 is fixedly mounted at a designated position on the upper surface of a substrate (M) of a main body of the terminal, and the substrate (M) is assembled with a lower casing 109, out of upper and lower casings, which form the main body of the terminal.

Lower assembly holes 104 are formed in the upper surface of the substrate (M) corresponding to the base 110, and lower assembly extensions 114 formed on the lower surface of the base 110 are elastically inserted into the lower assembly holes 104. Thereby, the base 10 is fixedly mounted on the substrate (M).

As shown in FIG. 2B, at least one contact protrusion 115 is formed on the external surface of the base 110 corresponding to the radiator line 120.

Preferably, a plurality of the contact protrusions 115 are formed on the horizontal upper surface of the base 110. However, the positions of the contact protrusions 115 are not limited thereto. That is, a plurality of the contact protrusions 115 may be formed on an incline surface or a vertical surface of the base 110 corresponding to an antenna line.

Preferably, the base 110 having a designated shape is made of a nonconductive resin having a dielectric constant of more than 1.

The nonconductive resin, which is used to form the base 110 by injection molding, is one selected from the group consisting of PBT, ABS, PC, PC/ABS, PA (nylon), LCP, and SPS. The range of the dielectric constant for exhibiting non-conductivity is 1˜200. Most preferably, the range of the dielectric constant of the nonconductive resin for facilitating the radiation of an electromagnetic wave is 1.5˜10.

The radiator line 120 is a radiating member, which is formed on the external surface of the base 110 and has a designated pattern according to characteristics of an antenna so that the radiator line 120 can receive/transmit a radio signal from/to a base station.

The radiator line 120 has a pattern, as shown in FIG. 3, but is not limited thereto. That is, the pattern of the radiator line 120 may be variously modified in consideration of the receiving sensitivity of a single frequency band or a multiple frequency band of the antenna to be set.

Preferably, in order to maximize the transmitting/receiving capacity of the antenna, the radiator line 120 provided on the external surface of the base 110 has the approximately same area as that of the upper surface of the base 110, which is exposed to the outside when the substrate (M) and the base 110 are assembled.

The radiator line 120 is formed in various patterns on the external surface of the base 110 by printing or coating a conductor in consideration of the receiving sensitivity of the antenna. As shown in FIG. 3, the radiator line 120 is patterned on the flat external surface of the base 110, thus being protruded from the upper surface of the base 110 to a designated height.

Further, the radiator line 120 may be formed by a double injection method, in which the base 110 having a designated shape made of a nonconductive resin is first formed by injection molding, and the radiator line 120 made of a conductive resin is secondarily formed on the external surface of the base 110 by injection molding. As shown in FIG. 3, the radiator line 120 is protruded from the flat external surface of the base 110 to a designated height.

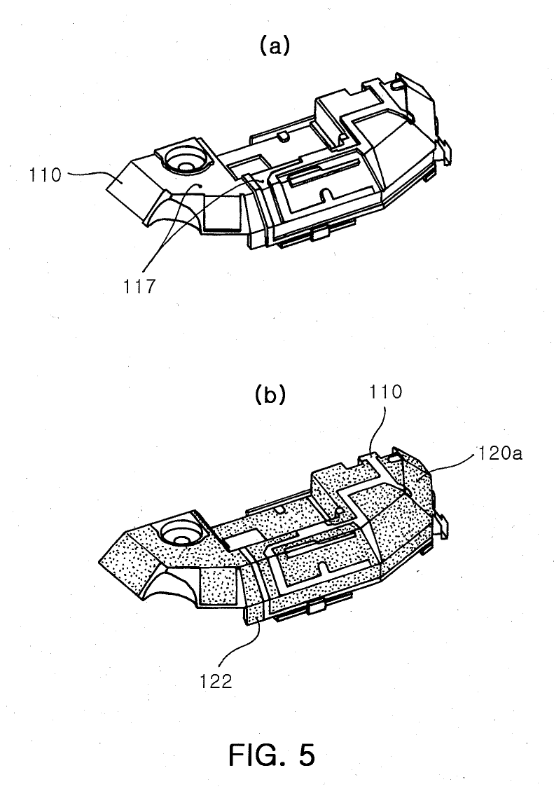

Alternately, a radiator line 120a is formed by forming a line groove 117 in a designated pattern, according to characteristics of the antenna, in the external surface of the base 110 when the base 110 is obtained by injection molding, as shown in FIG. 5A, and by filling the line groove 117 with a conductor by printing or coating, as shown in FIG. 5B.

Further, the radiator line 120a may be formed by a double injection method, in which the base 110, having the line groove 117 in a designated pattern according to characteristics of the antenna, made of a nonconductive resin is first formed by injection molding, and the line groove 117 of the base 110 is filled with the radiator line 120 made of a conductive resin, which is secondarily formed by injection molding.

Preferably, the radiator line 120 is made of a conductive resin having a volume resistivity of 1,000Ωcm, which is obtained by adding a conductive additive to a resin material.

Conductive additives, which are added to the nonconductive resin material so as to exhibit conductivity, include powders of Cu, Ag, Ni, and Al, powders of metallic oxides, such as zinc oxide, titan oxide, and tin oxide, powder of conductive carbon, and fine structures, such as carbon nano-tubes of fibers made of stainless and silver.

Preferably, in order to improve radiating characteristics of the antenna, the weight ratio of the conductive additive to the resin material is adjusted according to kinds of the conductive additive so that the radiator line 120 has a volume resistivity of less than 1,000Ωcm. More preferably, the radiator line 120 has a volume resistivity of less than 10Ωcm.

At least one feeding terminal 130 is provided on the upper surface of the substrate (M) corresponding to a feeding portion 122, i.e., one terminal of the radiator line 120, in such a manner that the feeding terminal 130 is electrically connected to the feeding portion 122.

The feeding terminal 130 includes contact pins, upper ends of which contact the feeding portion 12, and a pin connector having a spring member for supporting the contact pins upwardly using elastic force having a designated intensity, or an elastic piece, an upper terminal, serving as a free terminal, of which contacts the feeding portion 122, and a lower terminal, serving as a fixed terminal, of which is connected to the substrate (M).

In order to mount the base 110 on the substrate (M), the base 110 made of a nonconductive resin having a dielectric constant of 1˜2 is formed by injection molding using a mold (not shown).

The base 110 may have a flat external surface, on which the radiator line 120 is provided, as shown in FIG. 2A, or have the line groove 117 formed in a designated pattern in the external surface in consideration of the characteristics and the receiving sensitivity of the antenna, as shown in FIG. 5A.

The radiator line 120 may be formed on the base 110, formed by injection molding, in such a manner that the radiator line 120 is protruded from the surface of the base 110, by printing or coating a conductor in consideration of the predetermined characteristics and receiving sensitivity of the antenna, or by molding a conductive resin using a double injection method.

Further, the radiator line 120a may fill the line groove 117, formed in the external surface of the base 110 formed by injection molding, by printing or coating a conductor in consideration of the predetermined characteristics and receiving sensitivity of the antenna, or by molding a conductive resin using a double injection method.

Thereafter, the base 110 having the radiator line 120 or 120a is assembled with the substrate (M) of the main body of the terminal by inserting the lower assembly extensions 114 of the base 110 into the lower assembly holes 104 of the substrate (M) under the condition that the base 110 is disposed on the substrate (M).

Simultaneously, the feeding portion 122 of the radiator line 120 or 120a is connected to the feeding terminal 130 on the substrate (M), thereby electrically connecting the radiator line 120 or 120a and the substrate (M) to each other. Accordingly, the radiator line 120 or 120a can receive/transmit a radio signal from/to a base station.

As apparent from the above description, the present invention provides a built-in antenna module of a wireless communication terminal, in which a radiator line is formed in a designated pattern, according to antenna characteristics, on the external surface of a base mounted on the upper surface of a substrate of a main body of the terminal by a printing or coating method or a double injection method, so that a radiator is simply and conveniently provided directly on the external surface of the base without a conventional process for assembling a radiator, obtained by pressing and perforating a material having a sheet structure, with a base, thus simplifying the manufacturing process of the antenna module to reduce production costs, and rapidly coping with the design change of an antenna.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A built-in antenna module of a wireless communication terminal comprising:
at least one base mounted on the upper surface of a substrate of a main body of the terminal;
a radiator line formed in a designated pattern on the external surface of the base according to antenna characteristics; and
at least one feeding terminal electrically connecting the radiator line and the substrate.

2. The built-in antenna module according to claim 1, wherein the base includes at least one contact protrusion formed on the external surface thereof corresponding to the radiator line.

3. The built-in antenna module according to claim 1, wherein the base is made of a nonconductive resin having a dielectric constant of more than 1.

4. The built-in antenna module according to claim 1, wherein the radiator line is protruded from the external surface of the base by one method selected from the group consisting of a printing method, a coating method, and a double injection method.

5. The built-in antenna module according to claim 1, wherein the radiator line fills a line groove formed in the external surface of the base by one method selected from the group consisting of a printing method, a coating method, and a double injection method.

6. The built-in antenna module according to claim 5, wherein the line grooves has a designated pattern according to the antenna characteristics .

7. The built-in antenna module according to claim 1, wherein the radiator line is made of a conductive resin having a volume resistivity of 1,000Ωcm, which is obtained by adding a conductive material to a resin material.
